(19) United States
(12) Patent Application Publication
(10) Pub. No.: US 2019/0180040 A1
(43) Pub. Date: Jun. 13, 2019

(54) A DATA-NETWORK CONNECTED SERVER, A DEVICE, A PLATFORM AND A METHOD FOR CONDUCTING COMPUTER-EXECUTABLE EXPERIMENTS

(71) Applicant: Fondation de L'Institut de Recherche Idiap, Martigny (CH)

(72) Inventors: Sébastien MARCEL, Martigny (CH); André ANJOS, Vevey (CH)

(21) Appl. No.: 16/308,160

(22) PCT Filed: Jun. 21, 2016
(86) PCT No.: PCT/IB2016/053683

§ 371 Date: Dec. 7, 2018

(51) Int. Cl. G06F 21/60; G06F 21/62; H04L 29/06; G06F 9/50; G06F 9/48; G06F 11/34; G06F 11/36

(52) U.S. Cl. CPC G06F 21/604; G06F 21/6218; H04L 63/10; G06F 9/5061; G06F 2221/2141; G06F 11/3428; G06F 11/3664; G06F 2221/2149; G06F 9/4881

(57) ABSTRACT

The invention concerns a platform (1), a server (10, 10′) and a client device (20) for conducting computer-executable experiments. The server comprises a restricted-access memory module (11,11′) for locally storing a data structure with numerical values whose access is restricted to authorized devices and/or users. The server is provided with an instruction receiving module (12,12′) for receiving a list of executable instructions for conducting a computer-executable experiment based on numerical values with restricted access from the client device being not authorized to accessing numerical values with restricted access. The server comprises an execution module (13,13′) for conducting the experiment so to produce a numerical result; and a communication module (12,12′) for transmitting the result to the client device and/or to the user of the client device.

### FIELD OF THE INVENTION

The present invention concerns a platform for remotely conducting computer-executable experiments.

### DESCRIPTION OF RELATED ART

One of the key aspects of modern technological research and development lies in the use of computers for the simulation of technical phenomena and for the evaluation of collected data. Obtained data are then arranged in tables and figures and used in technical reports for supporting technical decisions.

Similarly, in computational science, computers are used for the simulation of known phenomena and for the evaluation on data collected from natural observations. Obtained data are commented and organized in tables and figures for pursuing scientific publications.

Commonly, these technical documentations and publications are reviewed by a reviewer or a group of reviewers in order to validate the presented data and conclusions, before such documents are used for technical decisions or public disclosures.

In the current practice, data sets, code and actionable software leading to results are excluded upon recording and preservation of articles. This system slows down potential scientific and technical development as reusing experiments conducted on a different platform or by a third party normally implies the re-development of software leading to original results so that the reviewing process of experiments would be mostly based on trust rather than on verifiable evidences.

Moreover, many experiments subjects such as those related to medical, biometrics and forensics applications also face legal barriers. Data used in these experiments should be handled according to stringent law requirements related to human rights for privacy as well as to territorial and governmental regulations on sensible data accessing.

Methods and systems for remote data access have been thus proposed for providing an access to sensible data pursuing privacy laws and/or territorial and governmental regulations on sensible data accessing.

U.S. Pat. No. 7,987,152 discloses a federation of autonomous clusters distributed across geographical areas for enterprise-wide uniform and consistent data management. A master cluster of the federation provides the slaves clusters with privacy rules for locally managing documents in compliance with federal regulations.

US pat. Appl. US2013/0198857 discloses a system infrastructure comprising remotely located center storing restricted-access data, such as data submitted to countries data privacy laws. The system infrastructure is thus arranged to restrict local access to these data to authorized users only.

US pat. Appl. US2014/0354405 discloses a federated biometric identification system, wherein a first device is configured for sending a collected biometric data to a second device for executing a search within his database.

### BRIEF SUMMARY OF THE INVENTION

An aim of the invention is to provide a solution for conducting a given computer-executable experiment on platform comprising a plurality of heterogeneous computing resources, in particular on a federated platform, i.e. a platform allows an interoperability and information sharing between semi-autonomous or autonomous computing systems that are de-centrally organized on multisite.

Another aim is to provide a solution for conducting a given computer-executable experiment with access-restricted data according to data privacy laws and territorials and governmental regulations.

According to the invention, these aims are achieved by means of a data network-connected server of claim 1, a data network-connected client device of claim 9, a platform of claim 19 and a method of claim 20.

The invention allows in an automated manner to process restricted data on a server in order to obtain a numerical result, without having access to those restricted data

The invention allows the researchers to have a reliable and easy access to third parties databases, but also a broader access to sequestered and potentially undistributable (non-distributable) data across various technical domains, disciplines and user communities.

The proposed solutions allow a supervisor of a database having sensible data to support modern technological researches and developments by allowing users to conduct computer-executable experiments on his database, while guaranteeing conformity with data privacy laws and governmental territorial and governmental regulation.

In an embodiment of the data network-connected server, the numerical values of the data structure are digital representations of physical entities or natural phenomena, preferably digitized representations of physical entities or natural phenomena. Preferably, the data structure comprises numerical values, e.g. a mono-dimensional, a bi-dimensional or a three-dimensional array of numerical values. In one embodiment, the collection of data comprises at least a computer-readably metadata for identifying, defining, describing and/or tagging the data structure and/or the numerical values. Alternatively or complementary, the metadata can comprises simulation and/or calculation tags or references. These solutions provide simulations of technical or know phenomena, algorithms and computational methods as well as evaluations of collected data.

In an embodiment, the server comprises distributed resources, in particular distributed computing units and/or distributed memory units for increasing the calculation and/or storage capabilities. Advantageously, the distributed resources are distributed within a single or a group of building or within a given political or geographical region accordingly to given data privacy laws and territorials and governmental regulations. The distributed resources can thus be connected to the server through a network providing data privacy, e.g. a Local Area network (LAN) that provides High data speed (i.e. providing a data transfer rate around 100 Mbps, i.e. 100·10⁶ bits per second, preferably more than 100 Mbps, preferably more than 1000 Mbps) while being configurable for providing data privacy.

In an embodiment, the server is configured to restrict the reception and/or the execution of the list of executable instructions to devices and/or users of a given group of devices and/or users not authorized to accessing said numerical values with restricted access, e.g. though credentials. This solution provides a management of the devices and users that can access the server for conducting a given computer-executable experiment, e.g. accordingly to service contracts, licenses or exclusions.

In one embodiment, the server is configured to variate the allocated computational resources for conducting computer executable experiment in function of the identity (e.g. credential) of the client device and/or the user of the client device, e.g. according to given service contracts or licenses linking the database proprietor and the device user.

Advantageously, the server is configured to verify that the numerical result is devoid of numerical values of the data structure with restricted access.

The invention further concerns a data network-connected client device.

In an embodiment, the client device is configured to receive the numerical result produced, on the data network-connected server, by the computer-executable experiment. This solution provides a single entry-point allowing users to conduct a computer-executable experiment on a data network-connected server of the platform.

In a preferred embodiment, the client device is configured to allow the user to select an instruction from a group of pre-defined instructions for setting up the given list of executable instructions. This solution supports the user in setting up the set of instructions by proposing him various instructions or groups of instructions performing predefined mathematical and/or logical functions, e.g. statistical, data type conversion and signal processing functions. Advantageously, the client device is configured to allow the user to use, create and/or share digital libraries of instructions and functions for setting up sets of instructions.

In an embodiment, the client device is configured to allow the user to store a plurality of lists of executable instructions and/or a plurality of the numerical results. Advantageously, the client device is configured to allow the user to share one or more of these lists of executable instructions and/or numerical results within a group of selected users. The selected users of the group can be, preferably individually, predefined or selectable by the user. Advantageously, the client device is further configured to provide the user with statistical or measurement or benchmarking tools operating on executable instructions and/or numerical results shared within the group of selected users.

These solutions provide reproducibility and verification of computer-executable experiments, in particular on various typologies of servers of the platform, as well as performance comparisons of distinct computer-executable experiments based on the same collection of data.

The invention further concerns a platform comprising the data-connected client device and one or a set of data network-connected servers.

Preferably, the data network connecting the client device and the servers comprises a Wide Area network. This solution provides a conduction of computer-executable experiments on restricted access data without geographical limitations

The proposed solutions allow the user to conduct his computer-executable experiment on a plurality of heterogeneous servers in a controllable confidential environment.

Moreover, the proposed solutions allow the user to controllably share workflows, sets of instruction and numerical results of conducted computer-executable experiment in such a way to permit a selected third party to review, verify and/or benchmark his experiment without to have to rewrite the computer-executable experiment.

The invention support thus the collaborations between various academics and/or industrials entities by permitting them to efficiently share and compare computer-executable experiments in a confidential framework, without demanding time for rewriting and/or adapting instructions for example for heterogeneous computing servers. As a consequence, researchers will be able to focus more on ideas and less on technical details.

Moreover, the proposed solutions allow the user to conduct third party computer-executable experiment by sending his shared sets of instructions to a single or a plurality of homogeneous or heterogeneous server platforms having targets collections of data for reviewing, verifying and/or benchmarking purposes.

### BRIEF DESCRIPTION OF THE DRAWINGS

The invention will be better understood with the aid of the description of an embodiment given by way of example and illustrated by the figures, in which:

FIG. 1 shows a view of a platform for conducting computer-executable experiments according to the invention;

FIG. 2 shows a flow diagram of a method for executing a computer-executable experiment according to the invention.

### DETAILED DESCRIPTION OF POSSIBLE EMBODIMENTS OF THE INVENTION

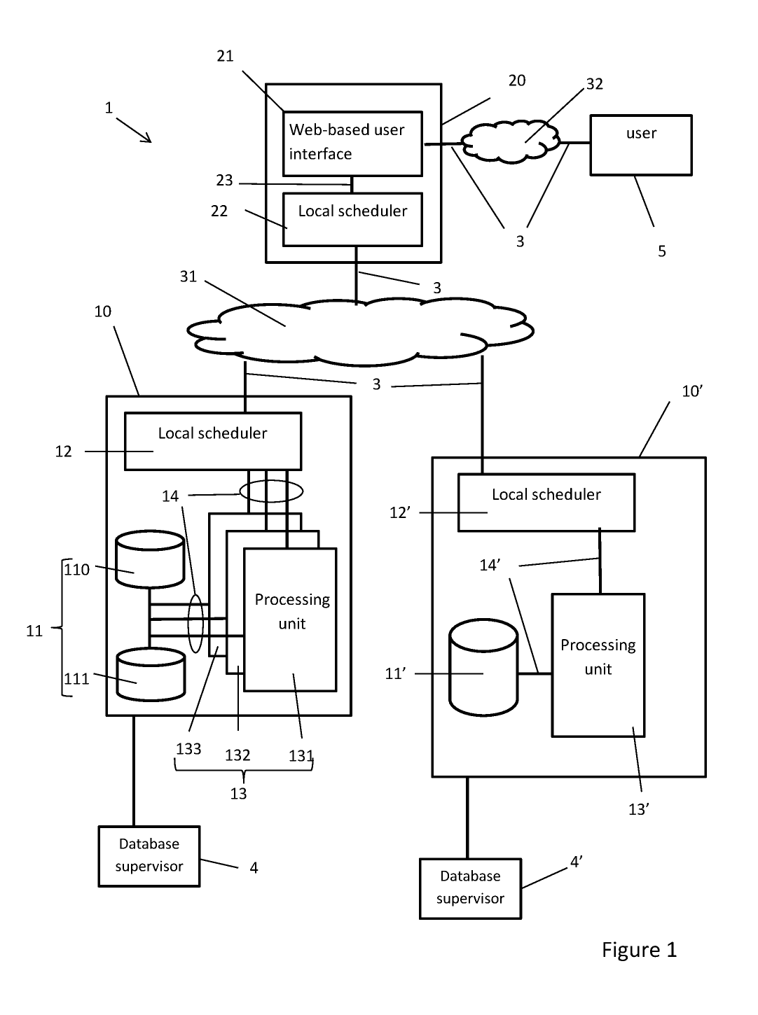

The FIG. 1 shows a computational platform 1 configured for allowing a client device 20 to conduct a computer-executable experiment on one or more servers 10, 10′ of the platform, e.g. on a first server 10 and/or on a second server 10′.

Advantageously, the platform 1 is structured as a multisite federated platform, i.e. it allows an interoperability and information sharing between semi-autonomous or autonomous computing systems that are de-centrally organized on multiple sites. Actually, the first and second server 10, 10′ as well as the client device 20 can be located in distinct sites, e.g. in a single or group of buildings located in distinct geographical regions.

Each server 10, 10′ of the platform 1 is endowed of computational and storage capabilities and connected to a data network 3,31.

According to the invention, the server 10, 10′ can be any computational device or system that is configured for managing access to local computational and storages resources in a network. Each server 10, 10′ is addressed in the following for simplicity and without limiting the invention as one physical entity, but could comprise as well a plurality of connected servers or computing devices distributing the functions of the server 10, 10′ described in the following.

Each server 10, 10′ of the platform 1 is configured for storing data destined to simulate or represent technical or known phenomena and/or to evaluate algorithms and computational methods by means of computer-executable experiments. Moreover, each server 10, 10′ of the platform 1 is configured for storing sensible data, i.e. data whose access is regulated by data privacy laws and/or territorial and governmental regulations.

Each server 10, 10′ of the platform 1 comprises a restricted access memory module 11,11′ for locally storing a given collection of data. The collection of data comprises at least a data structure with numerical values, wherein the access to at least a part of the numerical values is restricted to a group of authorized devices and/or users.

The group of authorized devices and/or users can be void, i.e. no user, respectively no device (excluding the hosting server), can be allowed to access numerical values with restricted access.

Advantageously, each server 10, 10′ of the platform 1 is configured to authorize a database supervisor to dynamically manage the access to the numerical values with restricted access. The managing can comprise, in particular, a dynamically selection of numerical values with restricted access and/or a dynamically election of the authorized devices and/or users.

The numerical values of the data structure are computer readable numerical values, e.g. digital representations of physical entities or natural phenomena, such as digitized representations of physical entities or natural phenomena.

The structure of the collection of data can thus, entirely or partly, depends on the typology of the physical entities or natural phenomena, the data acquisition method and device and eventually on the analog-to-digital conversion.

Alternatively or complementarily, parts or all numerical values of the data structure can be organized in a single or a plurality of mono-dimensional array (e.g. speech and music samples), bi-dimensional arrays (e.g. images), three-dimensional (e.g. B&W videos, depth or three-dimensional images) or multidimensional arrays (e.g. sequences of multispectral images, stereoscopic videos).

Advantageously, the collection of data can comprise a set or a plurality of distinct sets of computer-readably metadata.

A single or a set of metadata can be destined for defining a format of the data structure and/or a type of numerical values for providing computer readability of the numerical value of the data structure of the collection. This single or set of metadata permits thus to define how the numerical values are organized within the data structure and how they are digitally coded (formulaic representation).

A single or a set of metadata can be destined for identifying the data structure and/or groups or array of numerical values, e.g. for providing references and sources citing in particular in conducting experiments in a training or supervised mode.

A single or a set of metadata can be destined for describing parts of intermediate results or final result that the conducted experiment has to obtain when operating on the data structure and/or groups or array of numerical values, e.g. labelled training data structure or groups of numerical values. The single or set of metadata can comprise desired intermediate or output data. This single or a set of metadata provides experiment conductions in a supervised or unsupervised learning mode.

Each server 10, 10′ of the platform 1 comprises an instruction receiving module 12,12′ for receiving a list of executable instructions, through the data network 3, 31, from the client device 20 for conducting a given computer-executable experiment, on the server, based on the locally stored collection of data. The list of executable instructions comprises at least a mathematical or logical operation executable on at least one of the numerical values of the data structure with restricted access.

Eventually, the given computer-executable experiment with the list of executable instructions can be conducted based on the collection of data, in particular based on numerical values with restricted access, and on data furnished by the client device 20 or by a third device.

According to the invention, the computer-executable experiment comprises computer-executable simulations and data processing operating on numerical values, wherein the numerical values are computer-readable numeral values representing in particular physical entities or phenomena.

The computer-executable experiment can be a biometric experiment, e.g. recognizing or identifying a person from numerical values representing human behavioral patterns (e.g. gait, signature, keyboard typing, lip movement, hand-grip) and/or from human physiological traits (e.g. face, voice, iris, fingerprint, hand geometry, electroencephalogram, electrocardiogram, ear shape, body odor, body salinity, vascular, veins).

The computer-executable experiment can be a forensic science experiment, e.g. demonstrating the existence of an offense, selecting a list of persons of interest (forensic investigation), linking criminal cases (forensic intelligence), individualizing the perpetrators and inferring a modus operandi of a perpetrator from numerical values representing biometric data (e.g. fingermarks, Deoxyribonucleic acid-DNA, speech recordings, scars, marks, tattoos, human face and body).

The computer-executable experiment can be a biomedical imaging, e.g. image processing of an image produced by a X-Ray mammography, a magnetic resonance imaging (MRI), a computerized tomography (CT), a positron emission tomography (PET) and an electron microscopy. The image processing can comprises Shape Model Building and Matching (e.g. locating landmarks and the boundaries of structures in medical images), Mammographic Abnormality Detection (e.g. automatically detecting indications of cancerous growths within an image), Volumetric Image Segmentation (e.g. managing sets of 2D slices and 3D objects, assigning labels to 3D voxels), and Fluorescence Microscopy Image Noise Reduction (e.g. molecule-, cell-, or tissue-specific labeling in live cell cultures or in live animal organisms).

The computer-executable experiment can be a computer vision experiment, e.g. gaze estimation, Head-Eye scanpath and visual localization in 3D world, 3D reconstruction of large scale areas on demand, 3D object understanding and Learning about 3D objects from 2D resources, object recognition and categorization, and scene understanding from numerical values of captured images or videos.

The computer-executable experiment can be a visual recognition experiment, e.g. image characterization, object detection and description, extracting the identity of faces or recognizing facial attributes (e.g. gender, race, age, or the presence of distinguishing facial features or accessories), text spotting and reading from numerical values representing visual media (e.g. images and videos).

Most of the above-mentioned experiments, in particular when conducted in a supervised or unsupervised mode, involve a repetitive execution of mathematical or logical operations on a pre-defined or given group of numerical values with restricted access.

Each server 10, 10′ of the platform 1 further comprises an execution module 13,13′ for conducting, on the server, the computer-executable experiment with the list of executable instructions received from the client device and based on the collection of data, and eventually on the data furnished by the client device 20 or by the third device, so to produce a numerical result.

Each server 10, 10′ of the platform 1 further comprises a communication module 12,12′ for transmitting the numerical result produced by the given computer-executable experiment trough the data network to the client device and/or to an account of a given user.

In order to provide conformity with data privacy laws and with territorials and governmental regulations the numerical result has to be devoid of numerical values with restricted access.

The results obtained by conducting the above mentioned computer-executable experiments are intrinsically devoid of the numerical values with restricted access that have been used for conducting the experiment. The lists of instructions for executing the above mentioned computer-executable experiments describes, in general, nonlinear numerical functions operating on, or on parts of, the numerical values with restricted access. The conduction of most of the above-mentioned experiments produces a numeral indicator or index, such as a counter value, a ratio or a Benchmarking indicator.

Advantageously, the server can be configured, before to transmit the numerical result, to verify that the numerical result is devoid of numerical values of the data structure with restricted access. Moreover, the server can be configured to further verify that the numerical result is devoid of numerical values permitting a numerically reconstruction of numerical values of the data structure with restricted access.

Alternatively or complementarily, the server can be configured, to analyze the received set of instructions in such a way to guarantee that the generated numerical result is devoid of numerical values with restricted access or permitting a numerically reconstruction of numerical values of the data structure with restricted access.

The data network 3, 31 connecting the client device 20 with the servers 10, 10′ of the platform 1 can comprise networking systems or components providing no data privacy and extending over different states not sharing the same system of government, as no numerical values with restricted access is exchanged between the client and the servers of the platform 1. The data network 3, 31 can thus comprises, advantageously, a Wide Area network (WAN) 31 providing data exchanging by a broader telecommunication structure covering more states and national boundaries, potentially up to worldwide. The lower data speed of the Wan WAN, typically up to 150 Mbps, is not a limitation factor as the data exchange between the client device and the server concerns sets of instructions and numerical result having no real-time transmission and no huge data transmission canal requirements.

Each server 10, 10′ of the platform 1 provides thus the user 5 of the client device 20 to conduct a computer-executable experiment on a given server of the platform based on the locally stored numerical values with restricted access without infringing data privacy laws or regulations, even when the user is an unauthorized user with respect to the given server, i.e. the given server prevents the user 5 of the client 20 from accessing said numerical values with restricted access, e.g. by excluding the user from his group of authorized users of the given server.

Each server 10, 10′ of the platform 1 provides thus a conduction of a computer-executable experiment on a given server of the platform based on locally stored numerical values with restricted access without infringing data privacy laws or territorial and governmental regulations, even when the client device is an unauthorized device with respect to the given server, i.e. the given server prevents the client device 20 from accessing said numerical values with restricted access, e.g. by excluding the device from his group of authorized devices.

The platform permits thus a server to host data that are potentially undistributable (non-distributable), e.g. for privacy regulations, such as forensic or biomedical data of patients. The platform opens the exploratory capacity of research communities to run computer-executable experiment on inaccessible (i.e. never seen) data, while guaranteeing privacy laws such as EU data protection compliance.

The servers 10, 10′ of the platform 1 provide thus broader access to sequestered and potentially non-distributable data via computer-executable experiments in such a way to efficiently promote and support modern technological researches and developments while unending guaranteeing data privacy and conformity to territorial and governmental regulations. The user of the platform, via the client device, has not to lose time in checking the conformity of his experiment with respect to foreign privacy laws or regulations as well as to asking permissions, as a conduction of the computer-experiment on the server infringe no privacy laws as long as numerical values with restricted access are confined on the server.

One or more data-connected servers of the platform 1 can be a distributed server, e.g. the first server 10.

The first server 10 comprises distributed resources, in particular distributed computing units and distributed memory units for increasing the calculation and the storage capabilities.

The execution module 13 of the first server 10 comprises, for example, a plurality of distributed computing unit 131,132,133 that are operationally connected to others operational components of the first server 10, in particular to the restricted access memory module 11 and to the instruction collecting module 12, by one or more data bus or network.

In case of distributed computing units in form of multiple-core on chip, e.g. a multicore Digital Signal Processor (DSP) or processor, and/or in form of multiple-chip on card, the distributed computing units are operationally connected to the others operational components of the server by one or more data bus, preferably by dedicated High Speed Data Bus.

In case one or more distributed computing unit 131,132,133 in form of semi-autonomous or autonomous processing units, these units are preferably data-connected to others operational components of the first server 10 by a data network providing data privacy and eventually High data speed, e.g. a Local Area network (LAN) providing a data transfer rate above 100 Mbps, advantageously above 1000 Mbps, and configurable for providing data privacy.

The restricted access memory module 11 of the first server 10 comprises distributed memory units 110, 111 that are operationally accessible, i.e. connected to others operational components of the server 10, in particular by one or more data bus or network.

In case of distributed memory units in form of single storage units, e.g. hard disks (HDD) and solid state drives (SSD), the distributed memory units are operationally accessible to the server by one or more data bus, preferably by dedicated High Speed Data Bus.

In case of distributed memory unit 131,132,133 in form of semi-autonomous or autonomous memory units, e.g. network-attached storages (NAS) and CPU-provided computer data storages, these units are preferably accessible by a data network providing data privacy and eventually High data speed (e.g. above 100 Mbps, preferably above 1000 Mbps), e.g. a Local Area network (LAN).

Advantageously, the distributed resources, e.g. computing and/or memory units, of the first server 10 are distributed within a single or a group of building, even within a given political or geographical region, in conformity with data privacy laws and/or territorials and governmental regulations that apply on the collected data. The distributed resources can thus operationally connected to the other components of the server through a data network providing data communications in conformity with the applicable data privacy and territorial and governmental regulations. A Local Area network (LAN), a campus Area network (CAN, e.g. interconnected LANs interconnecting a variety of building) and/or a metropolitan Area networks (MAN, e.g. networking technologies covering an area from a few city blocks up to the entire area of a city) can be configured to constitute the data network 14 connecting the distributed resources of the server 10.

Each server 10, 10′ of the platform 1 can advantageously be configured to restrict the reception and/or the execution of the list of executable instructions to devices of a group of selected, unauthorized client devices, i.e. client device not authorized to accessing the numerical values with restricted access of the concerned server.

Alternatively or complementarily, each server 10, 10′ of the platform 1 can advantageously be configured to restrict the reception and/or the execution of the list of executable instructions to users of a group of selected, unauthorized users, i.e. users not authorized to accessing the numerical values with restricted access of the concerned server.

These server configurations provide a management of the client devices and users that can conduct, on the concerned server, computer-executable experiments, e.g. for enforcing customer-specific service contracts or licenses.

The restriction can be implemented through identification information or identifier, e.g. digital credentials. The server can thus be configured to allow a database supervisor to setup credentials for restricting, on the server, the reception and/or the execution of the list of executable instructions. Meanwhile, the server can be configured to require, on the concerned server, a credential from the client device 20 and/or from the user 5 controlling the client device 20 for authorizing, on the concerned server, the reception and/or the execution of the set of instructions.

Each server 10, 10′ of the platform 1 can advantageously be configured to variate and/or adapt the allocated computational resources for conducting a single or a group of computer executable experiments in function of the numbers of sets of instructions that are in execution, and/or are scheduled to be executed, on the concerned server.

This server configuration provides a management of the computational resources that are allocated or allocable for conducting, on the concerned server, the computer-executable experiments, in particular in case of distributed or multiple computational units.

Each server 10, 10′ of the platform 1 can advantageously be configured to variate the allocated computational resources for conducting computer executable experiment in function of the identity of the client device 20 and/or the user 5 of the client device, e.g. in function of the provided identification information, identifier or credentials.

This server configuration further provides a management of the computational resources that are individually allocated to a given client devices and/or users for conducting, on the concerned server, a single or a plurality of computer-executable experiments, in particular for enforcing customer-specific service contracts and licenses.

The data network-connected client device 20 of the platform 1 comprises a first module 21 for authorizing a user 5 to access the client device 20 for collecting and/or setting up, on the client device, a given list of executable instructions for conducting a computer-executable experiment on one or more servers 10, 10′ of the platform 1.

The list of executable instructions comprises at least a mathematical or logical operation executable on at least one of the numerical values with restricted access of the one or more servers.

Advantageously, the client device 20 of the platform 1 is configured to simultaneously provide individual access to distinct users, e.g. through distinct accounts assigned to the users.

The client device 20 of the platform 1 may be a client device not authorized to access the numerical values with restricted access on at least one server of the platform, e.g. due to data privacy laws, to territorial and governmental regulations on sensible data accessing or to economical or confidential restrictions (e.g. Know-how protection). One or more servers (up to all the servers of the platform 1) prevent the client device 20 from accessing their numerical values with restricted access, e.g. by excluding the device from their groups of authorized devices. In particular, the numerical values with restricted access of these servers (preventing the client device from accessing it) are not, previously or currently, received from the client device 20, i.e. the client device 20 provides none of these numerical values with restricted access.

Alternatively or complementarily, the user 5 authorized to access the client device 20 for collecting or setting up the set of instruction is a user not authorized to accessing the numerical values with restricted access on at least one of the given server, e.g. due to data privacy laws, to territorial and governmental regulations on sensible data accessing or to economical or confidential restrictions (e.g. Know-how protection). One or more servers (up to all the servers of the platform 1) prevent the user of the client device 20 from accessing their numerical values with restricted access, e.g. by excluding the user from their groups of authorized user. In particular, the numerical values with restricted access of these servers (preventing the user of the client device from accessing it) are not, previously or currently, received from the user 5 of the client device 20, i.e. the user of the client device provides none of these numerical values with restricted access.

The client device 20 further comprises a scheduler module 22 for transmitting, though the data network 3,31, the list of executable instructions collected or set up on the client device to the given server 10,10′ for conducting, on the given server, a given computer-executable experiment based on numerical values with restricted access of the given server.

The scheduler module 22 can be configured to, manually, semi-automatically or fully-automatically, schedule a same computer-executable experiment on a plurality of servers of the platform that locally store numerical values compatible with the computer-executable experiment. Alternatively, the scheduler module 22 can be configured for collecting the typology of the collections of data from the servers of the platform 1 in such a way to propose the (most) adequate ones to the user of the client device when collecting or setting up his set of instructions.

The client device can be configured to allow the user to setting up, on the client device, a list of executable instructions through a toolchain, i.e. a set of workflow, in particular for executing a set of computer-executable experiments on a single or on a plurality of servers of the platform. The scheduler module 22 can thus be configured to establish the order in which the computer-executable experiments (as defined by the toolchains) are executed and, eventually, on which servers of the platform.

Advantageously, the client device 20 is configured to receive the numerical result produced, on the data network-connected server, by a conduction of the given computer-executable experiment, e.g. via the scheduler module 22.

The user can thus, advantageously manually or semi-automatically, select a combination of databases and, eventually computing requirements, in such a way that experiments are directed to servers of the platform and the provided numerical results are centrally received in the client device and, eventually, automatically combined within the client device.

Alternatively or complementarily, the client device 20 can comprising a web-based (web-browser-based) user interface 21 configured, for example, to remotely provide or support user authorization and access, instructions collection and/or setting up, and/or outputting of the received numerical result. In particular, web-based user interface 21 can provide Web-based analysis and publishing. Users (e.g. researchers) can thus be to leverage from all gathered experimental data for in-depth analysis on a potentially very high number of results, which may provide more thorough understanding of scientific results and their overall impact.

Advantageously, the web-based user interface can be configured for handling data input and output for the platform as a main point of interaction for users of the platform.

The web-based user interface 21 can thus provide the user 5 with a remote access, e.g. an access to a user located outdoor the regional or governmental area limits of the client device 20. Moreover, this configuration provides a single entry-point, potentially worldwide, for conducting a computer-executable experiment on servers of the platform 1.

The client device can be configured to allow the user to select an instruction from a group of pre-defined instructions for setting up the given list of executable instructions. The client device can thus be configured to allow the user to select an instruction, a group of instructions or a workflow, from a digital library of instructions and functions that is accessible, for example, via the web-based user interface 21. Moreover, the client device can be configured to further permit the user to add instructions or workflows to the library, even to create his library and to share it with a group of selected users of the client device.

These configurations support the user in setting up the set of instructions by proposing him various instructions or groups of instructions for performing predefined mathematical and/or logical functions, e.g. statistical, data type conversion and signal processing functions. In particular, these configurations permit the user of the client device to benefit of a rapid access to dedicated instructions or functions of near technical domains up to pure mathematical ones.

The client device can be configured to allow the user to store the workflow or set of instruction that have been collected or set up on the client device and the numerical result that have been obtained on the server by conducting the computer-executable experiment. In particular, the client device can be configured to allow the user to store a plurality of workflows, lists of executable instructions and/or a plurality of the numerical results in such a way that the user can selectively use, edit and/or output them, e.g. via the web-based user interface 21.

Advantageously, the client device can be configured to allow the user to selectively share one or more of these lists of executable instructions (eventually through one or more toolchain) and/or numerical results within a group of selected users. The selected users of the group can be, preferably individually, predefined or selectable by the user between the users being authorized to access the client device, e.g. by inserting or removing a given user to or from the group of selected users.

Advantageously, the client device can be configured to provide the user for being part of a plurality of distinct groups of users, e.g. through the web-based user interface 21.

The platform provides thus confidentiality to the users, as all interaction, e.g. the toolchain, sets of instructions and the related numerical results, will be kept private until users or groups of users decide to share their contributions. This will allow researchers from academia and industry to conduct innovative work based on the platform without compromising confidentiality. Contributions can be shared among users, groups or with the general public visiting the platform at any instant.

The web-based user interface provides a Web-based portal that allows instructions collecting and setting up, as well as search, schedule, or refer to computer-executable experiments and results, from anywhere as no specific software is required to be installed on the client device other than a web-browser.

These configurations provide reproducibility and verification of computer-executable experiments on various homogeneous and heterogeneous platform as well as performance comparisons of distinct computer-executable experiments based on the same collection of data.

These configurations further allow the user to controllably share the set of instruction (eventually toolchain and workflows) and numerical results of conducted computer-executable experiment in such a way to permit a selected third party to review, verify and/or benchmark his experiment without to have to rewrite the computer-executable experiment. Analogously, the user is allowed to conduct third party computer-executable experiment by sending third party shared sets of instructions to servers having targets collections of data for reviewing, verifying and/or benchmarking purposes.

Advantageously, the client device can be further configured to provide the user with tools to analyze, measure and/or compare toolchains, workflows, sets of instructions and/or numerical results that are shared within the group of selected users. In particular, the tools can provide statistical, measurement and benchmarking functions. The client device can further being configured to provide an outputting of the results generated by these tools, e.g. via the web-based user interface.

The platform supports the collaborations between various academics and/or industrials entities by permitting them to efficiently share and compare computer-executable experiments in a confidential framework, without demanding time for rewriting and/or adapting instructions for example for ad-hoc computing servers. The platform provides data privacy and proper authorship attribution to each user of the platform via the client device.

Advantageously, the client device can be further configured to provide the user or group of users to publicly share, i.e. publish, selected toolchains, workflows, sets of instructions and/or numerical results so that any user of the client device could access it.

In particular, the provided solutions allow the researchers to have not only a reliable and an easy, potentially worldwide, access to third parties discoveries, but also a broader access to sequestered and potentially undistributable data, existing functions, toolchains and algorithms across various technical domains, disciplines and user communities via computer-executable experiments.

The client device can be a server, a personal computer, a laptop or a smartphone provided with data communication capabilities and eventually with an I/O interface, e.g. keyboards and screens or touch screen.

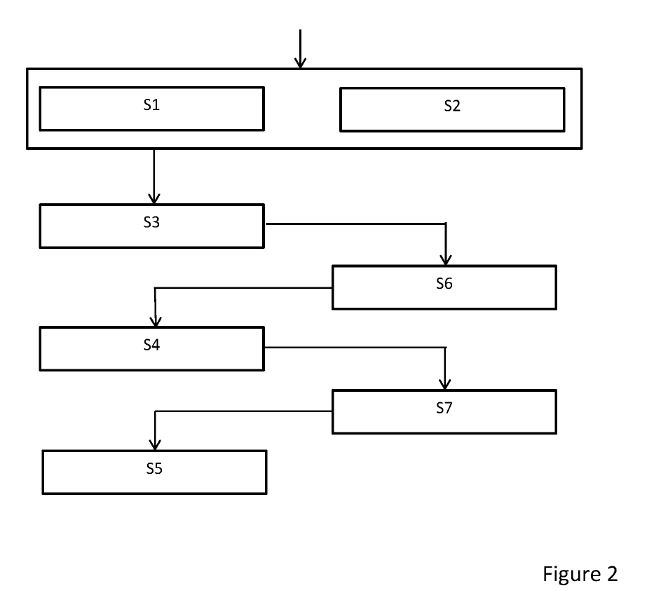

A platform for conducting a computer-executable experiment according to the invention can thus be configured by means a method for executing a computer-executable experiment that is schematically illustrated in FIG. 2.

The method for executing a computer-executable experiment, in particular operating on restricted-access data, comprises a first step of locally storing (S1) a given collection of data on a data network-connected server comprising a data structure with numerical values.

The method then comprises a step of restricting accessing (S2), on data network-connected server, to at least a part of the numerical values to authorized devices and/or users.

Depending on the server configuration, the steps of locally storing and of restricting accessing can be substantially executed either in parallel or sequentially, eventually inversing the order of the steps.

The steps of locally storing and of restricting accessing can be executed or lead by a data supervisor.

The method comprises a step of receiving (S3), on the data network-connected server, a given list of executable instructions through the data network, from a client device controlled by a user for conducting a given computer-executable experiment on the server based on the collection of data. The list of executable instructions comprises at least a mathematical or logical operation executable on at least one of the numerical values of the data structure with restricted access, while the client device and/or the user controlling the client device are not authorized to accessing the numerical values with restricted access.

According to the invention, the client device and/or the user controlling the client device have no direct access to the numerical values with restricted access as being non-authorized (unauthorized) by the step of restricting accessing (S2), i.e. the client device and/or the user controlling the client device is excluded from the group of authorized devices and/or users. In particular, the numerical values with restricted access are not received from the client device.

The step of receiving (S3), on the data network-connected server, the given list of executable instructions can comprise a step of receiving data furnished by the client device or by a third device.

The method comprises then a step of conducting (S4), on said server, the given computer-executable experiment with the list of executable instructions based on the collection of data, in particular based on numerical values with restricted access, so to produce a numerical result.

Eventually, the given computer-executable experiment with the list of executable instructions can be conducted based on the collection of data, in particular based on numerical values with restricted access, and on data furnished by the client device or by a third device.

The method comprises then a step of transmitting (S5) the numerical result produced by the given computer-executable experiment through the data network to the client device and/or to an account of the user controlling the client device.

The method can comprise a step of analyzing (S6) the received set of instructions in such a way to guarantee that the generated numerical result is devoid of numerical values permitting a reconstruction of numerical values with restricted access. Otherwise, e.g. the analysis indicates that the privacy rule or territorial and governmental regulations are violated or there is a risk of violation in case the generated numerical result is communicated to non-authorized devices or users, the conduction of the experiment is impeded.

The method can comprises a step of verifying (S7) that the numerical result is devoid of numerical values permitting a numerically reconstruction of numerical values of the data structure with restricted access. Otherwise, e.g. the verification indicates that the privacy rule or territorial and governmental regulations are violated or there is a risk of violation in case the numerical result is communicated to non-authorized devices or users, the transmission of the numerical result is impeded.

### LIST OF REFERENCE NUMERALS

1 Federated platform

10,10′ Data network-connected server

11,11′ Restricted-access Database

110,110 Storing element

12,12′ Local scheduler

13,13′ Processing module

131,132,133 Processing unit

14 Local data network

14′ Data bus

20 Front-end server

21 Web-based user interface

22 Local scheduler

23 Data bus or network

3 Data network

31,32 Wide Area Network

4,4′ Database supervisor

5 User

1. A data network-connected server for conducting computer-executable experiments, the server comprising:
a restricted access memory module for locally storing a given collection of data comprising a data structure with numerical values, wherein the access to at least a part of the numerical values is restricted to authorized devices and/or users;
an instruction receiving module for receiving through the data network a list of executable instructions from a client device controlled by a user, wherein the list of executable instructions is configured for conducting a computer-executable experiment on the server based on the collection of data; wherein the list of executable instructions comprises at least a mathematical or logical operation executable on at least one of the numerical values of the data structure with restricted access;
an execution module for conducting, on the server, the computer-executable experiment with the list of executable instructions based on the collection of data so as to produce a numerical result;
a communication module for transmitting the numerical result produced by the computer-executable experiment through the data network to the client device and/or to an account of said user;
wherein
said server prevents said client device and said user from accessing said numerical values with restricted access on which said experiment is based.

2. The server according to claim 2, the server and/or the restricted access memory module being configured to authorize a database supervisor to dynamically manage the access to said at least a part of the numerical values, in particular to dynamically define the part of numerical values with restricted access, in particular to dynamically define authorized devices and/or users.

3. The server according to claim 2, the server being configured to restrict, on the server, the reception and/or the execution of the list of executable instructions to a group of devices and/or users not authorized to accessing said numerical values with restricted access.

4. The server according to claim 3, the server being configured to allow a database supervisor to setup credentials for restricting, on the server, the reception and/or the execution of the list of executable instructions.

5. The server according to claim 1, the server being configured to require, on the server, a credential from the client device and/or from the user controlling the client device.

6. The server according to claim 5, the server being configured to dynamically allocate computational resources for executing the list of executable instructions, wherein an amount of allocated computational resources is determined from the provided credential.

7. The server according to claim 1, wherein the list of executable instructions constitutes a nonlinear numerical function operating on said numerical values with restricted access in such a way that said numerical values with restricted access are numerically unidentifiable from the numerical result.

8. The server according to claim 1, wherein the list of executable instructions comprises a group of mathematical or logical operations destined to be repeatedly executed on a pre-defined group of numerical values with restricted access.

9. A data network-connected client device comprising:
a first module for authorizing a user to access the client device and for collecting and/or setting up, on the client device, a list of executable instructions for conducting a computer-executable experiment on a data network-connected server locally storing a collection of data comprising a data structure with numerical values; the client device and/or the user accessing the client device are/is not authorized to access at least a part of said numerical values; and wherein the list of executable instructions comprises at least a mathematical or logical operation executable on at least one of the numerical values of the data structure with restricted access;
a scheduler module for transmitting though the data network the list of executable instructions to the data network-connected server for conducting, on the data network-connected server, the computer-executable experiment with the list of executable instructions based on numerical values to which the client device and/or the user have no access. so as to produce a numerical result.

10. The client device according to claim 9, the client device being further configured to receive though the data network the numerical result produced, on the data network-connected server, by the computer-executable experiment.

11. The client device according to claim 9, the first module comprising a web-based user interface, in particular providing outputting of the received numerical result.

12. The client device according to claim 9, the client device being configured to allow the user to select an instruction from a group of pre-defined instructions for setting up the list of executable instructions.

13. The client device according to claim 9, the client device being configured to allow the user to store a plurality of lists of executable instructions, wherein each list of executable instructions comprises at least a mathematical or logical operation executable on at least one of the numerical values of the data structure with restricted access.

14. The client device according to claim 9, the client device being configured to allow the user to store a plurality of the numerical results; each numerical result being produced, on the data network-connected server, by a distinct computer-executable experiment conducted with a list of executable instructions based on said collection of data.

15. The client device according to claim 9, the client device being configured to allow the user to share the list of executable instructions or one list of said plurality of lists of instructions, and/or the numerical result or one numerical result of said plurality of numerical results within a group of selected users.

16. The client device according to claim 15, the client device being configured to allow the user to individually select and/or remove the users of said group of selected users.

17. The client device according to claim 15, the client device being configured to provide a benchmarking measurement and/or comparison that is determined as a function of a numerical reference and one of lists of executable instructions or numerical results shared within the group of selected users.

18. The client device according to claim 15, the client device being configured to provide a benchmarking measurement and/or comparison that is determined as a function of at least two of lists of executable instructions or numerical results shared within the group of selected users.

19. A platform allowing a user of a device to conduct remote computer-executable experiments, comprising
a data network-connected server according to claim 1; and
a data network-connected client device according to claim 9;
the server and the client device being reciprocally connected via a data network in such a way to provide bidirectional data exchange between the server and the client device.

20. A method for executing a computer-executable experiment, in particular operating on restricted-access data, the method comprising steps of:
storing a collection of data locally on a data network-connected server comprising a data structure with numerical values;
restricting access, on said server, to at least a part of the numerical values to authorized devices and/or users;
receiving, on said server, a list of executable instructions through the data network, from a client device controlled by a user for conducting a computer-executable experiment on said server based on the collection of data; wherein the list of executable instructions comprises at least a mathematical or logical operation executable on at least one of the numerical values of the data structure with restricted access; wherein the server prevents said client device and said user from accessing said numerical values with restricted access on which said experiment is based;
conducting, on said server, the computer-executable experiment with the list of executable instructions based on the collection of data so as to produce a numerical result; and
transmitting the numerical result produced by the computer-executable experiment through the data network to the client device and/or to an account of said user.
